(19) United States
(12) Patent Application Publication
(10) Pub. No.: US 2006/0035066 A1
(43) Pub. Date: Feb. 16, 2006

(54) Process producing an optical security component

(75) Inventors: Hugues Souparis, Nogent Sur Marne (FR); Thierry Sevegrand, Issy Les Moulineaux (FR)

Correspondence Address: IP GROUP OF DLA PIPER RUDNICK GRAY CARY US LLP, 1650 MARKET ST, SUITE 4900, PHILADELPHIA, PA, 19103, US

(73) Assignee: Hologram Industries, a corporation of France, Bussy Saint Georges (FR)

(21) Appl. No.: 11/188,520

(22) Filed: Jul. 25, 2005

Related U.S. Application Data
(63) Continuation of application No. PCT/FR04/00251, filed on Feb. 3, 2004.

(30) Foreign Application Priority Data
Feb. 3, 2003 (FR) FR 03/01221

(51) Int. Cl. B32B 3/00

(52) U.S. Cl. 428/195.1

(57) ABSTRACT

A process for producing an optical security component including stamping a transparent film with a matrix having a first type of zone whose surface state is matte, and a second type of zone whose surface state has cuttings/slits for forming a diffraction network; depositing a layer of dielectric material with a high optical index on an entire surface, under a vacuum, on the film; partial metallization of the film by depositing a layer of metal on only part of the zones of each types whereas the other part remains transparent; and applying an adhesion layer.

### RELATED APPLICATION

This is a continuation of International Application No. PCT/FR2004/000251, with an international filing date of Feb. 3, 2004 (WO 2004/069553, published Aug. 19, 2004), which is based on French Patent Application No. 03/01221, filed Feb. 3, 2003.

### FIELD OF THE INVENTION

This invention relates to authentication of documents, more particularly, to optical identification components implementing diffracting elements.

### BACKGROUND

Optical identification components are used in metallized form to mark credit cards or banknotes. They are then manufactured in the form of tracks or threads or even surface components called “patches.” They are sometimes demetallized locally in such a manner as to form a recognizable contour having the shape of a logo or also to identify a transparent frame.

They are also used in transparent form, permitting a reading via transparency. They are then used for the identification of ID cards, passports, badges or access cards.

Further, certain components comprise a recognizable colored element to increase security against counterfeiting.

The elements are applied on the document or the piece to be secured by pressing, lamination or hot or cold transfer.

U.S. Pat. No. 5,513,019 describes a security sign comprising a phase hologram engraved in relief in a Mylar® film with a reflective layer of tungsten oxide, zinc sulfide or a mixture. The relief microtexture produces a semitransparent hologram permitting visualization of complementary information.

WO 01/36213 discloses a component to authenticate a document or a product having an embossed, transparent plastic film for presenting at least one diffraction network/grating whose embossed surface is at least partially covered by a layer of metallization, characterized in that the embossed film has a first zone producing a rainbow effect along a first orientation of the component relative to a lighting direction, which rainbow effect disappears when the component is oriented perpendicularly to the first orientation, and has a second zone coated with a dielectric material producing a colored effect with a first color for a first orientation of the component, and a second, different color for the orientation perpendicular to the first orientation.

The first zone is a metallized zone and the second zone is a zone with a deposit of a dielectric material. The component is realized in accordance with a process comprising stamping a transparent film, metallizing the stamped film, partial demetallization of the stamped film and depositing a dielectric material.

It would therefore be advantageous to provide such components by combination into one and the same component of habitually produced characteristics:
by a holographic or diffracting mark on a metallized background,
by a holographic or diffracting mark on a transparent background,
by a mark imprinted on a transparent background,
by micro-signs (characters, lines, shapes).

The combination of these different characteristics renders the component particularly difficult to reproduce.

### SUMMARY OF THE INVENTION

This invention relates to a process for producing an optical security component including stamping a transparent film with a matrix having a first type of zone whose surface state is matte, and a second type of zone whose surface state has cuttings/slits for forming a diffraction network; depositing a layer of dielectric material with a high optical index on an entire surface, under a vacuum, on the film; partial metallization of the film by depositing a layer of metal on only part of the zones of each type whereas the other part remains transparent; and applying an adhesion layer.

This invention also relates to a matrix for an optical security component including a first type of zone having a matte surface state, a second type of zone having a surface state with cuttings for forming a diffraction network, and a third type of zone having a smooth surface state, wherein some of the zones have a small dimension less than about 0.5 mm.

This invention further relates to a security compound having colored zones corresponding to a diffraction network, zones with a matte, metallic aspect and zones with an aspect of a reflecting mirror, some of which zones have a small dimension less than about 0.5 mm.

### BRIEF DESCRIPTION OF THE DRAWING

The invention will be better understood from a reading of the following description that makes reference to the attached drawings corresponding to a non-limiting exemplary embodiment.

FIG. 1 shows an enlarged view of an example of a component realized in accordance with the process of the invention.

### DETAILED DESCRIPTION

This invention concerns a process for producing an optical security component comprising stamping a transparent film, depositing a layer of dielectric material with a high optical index on the entire surface under a vacuum, partial metallization of the film and an adhering stage, characterized in that the stamping is achieved with a matrix with a first type of zone whose surface state is matte, and a second type of zone whose surface state has cuttings for forming a diffracting network, and in that metallization comprising depositing a layer of metal on only part of the zones of each type whereas the other part remains transparent.

The stamping is advantageously realized with a matrix with, in addition, a third type of zone whose surface state is smooth.

According to one aspect, the matrix has, in addition, a fourth type of zone whose surface state is semi-matte with a granularity lower than the matte surface state.

According to another aspect, some of the metallized parts have a smaller dimension less than about 0.5 mm. According to another aspect, some of the transparent parts have a smaller dimension less than about 0.5 mm.

The invention also relates to a matrix comprising a first type of zone whose surface state is matte, a second type of zone whose surface state has cuttings/slits for forming a diffraction network, and a third type of zone whose surface state is smooth, some of which zones have a smaller dimension less than about 0.5 mm.

It also relates to a security component having colored zones corresponding to a diffraction network, zones with a matte, metallic aspect and zones with an aspect of a reflecting mirror, some of which zones have a smaller dimension less than about 0.5 mm.

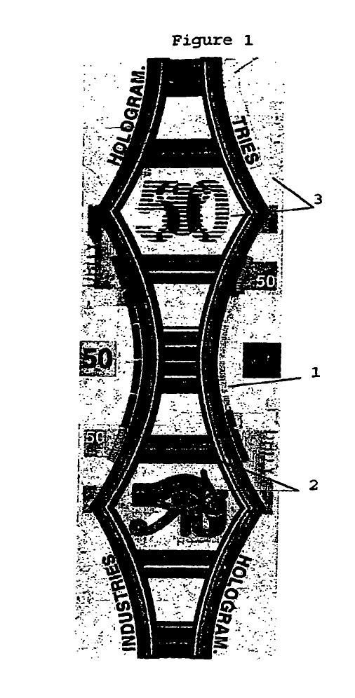

Turning now to FIG. 1, the security component has transparent zones 1 with a matte aspect, metallized zones 2 with a mirror effect and colored zones 3. This component is realized by a succession of only four operations. The first operation is stamping a plastic film, e.g., a transparent polyester film.

Stamping is performed with a matrix with three or four types of surface states:
a smooth, polished surface state corresponding to the film zones surrounding the active part,
a matte surface state with a random granularity for the zones that are to have a colored effect and for the zones that are to have a transparency,
a structured surface state for forming a diffraction network on the film, and
optionally, a semi-matte surface effect with a low granularity for zones that are to have a pastel aspect.

The second operation comprises depositing, in a vacuum, a layer of dielectric material with a high optical index, e.g., zinc sulfide (ZnS), on the entire surface of the stamped film.

The third operation is partial metallization of the film surface in register with the stamped zones to form a diffraction network. The metallization covers only a part of the diffraction zones and only a part of the matte zones, and certain elements of the covered zones are very fine with a small dimension lower than about 0.5 millimeters.

The last stage is a stage of adhesion by lamination or coating with an adhesive layer.

The colored mark has a clear gray color to be visible on the metallic parts. It has a matte metallic aspect that contrasts strongly with the mirror aspect. On the other hand, it is imperceptible on the transparent parts.

It can also be optically active by being combined with other optical effects to have a pastel color or a filigree effect.

1. A process for producing an optical security component comprising:
stamping a transparent film with a matrix having a first type of zone whose surface state is matte, and a second type of zone whose surface state has cuttings/slits for forming a diffraction network;
depositing a layer of dielectric material with a high optical index on an entire surface, under a vacuum, on the film;
partial metallization of the film by depositing a layer of metal on only part of the zones of each types whereas the other part remains transparent; and
applying an adhesion layer.

2. The process according to claim 1, wherein stamping is achieved with a matrix with a third type of zone whose surface state is smooth.

3. The process according to claim 2, wherein stamping is performed with a matrix that also has a fourth type of zone whose surface state is semi-matte with a granularity lower than the matte surface state.

4. The process according to claim 1, wherein some metallized parts have a small dimension less than about 0.5 mm.

5. The process according to claim 1, wherein some transparent parts have a small dimension less than about 0.5 mm.

6. A matrix for an optical security component comprising:
a first type of zone having a matte surface state, a second type of zone having a surface state with cuttings for forming a diffraction network, and a third type of zone having a smooth surface state, wherein some of the zones have a small dimension less than about 0.5 mm.

7. The matrix according to claim 6, further comprising a fourth type of zone having a semi-matte surface state with a granularity less than the matte surface state.

8. A security compound having colored zones corresponding to a diffraction network, zones with a matte, metallic aspect and zones with an aspect of a reflecting mirror, some of which zones have a small dimension less than about 0.5 mm.
